(19) United States
(12) Patent Application Publication
(10) Pub. No.: US 2003/0160040 A1
(43) Pub. Date: Aug. 28, 2003

(54) Support accessory for making pizza

(76) Inventor: Osvaldo Santora, Pelican Island, NJ (US)

Correspondence Address: CLIFFORD G. FRAYNE, Suite 7A, 136 Drum Point Road, Brick, NJ, 08723, US

(21) Appl. No.: 10/083,262

(22) Filed: Feb. 27, 2002

(51) Int. Cl. A21B 1/00

(52) U.S. Cl. 219/400

(57) ABSTRACT

An elevated support assembly cooperable with a counter top for the making of pizza and insuring that the pizza peel, nor the oven floor become contaminated from spilled toppings, support assembly having a support surface for supporting a pizza peel in a horizontal position for positioning the pizza crust on the pizza peel, the elevated support surface being less than the area of the area of the pizza peel, and at least one of the support surfaces of the support accessory extending vertically downwardly from one edge thereof so as to abut and engage the edge of the counter top for stability.

### BACKGROUND OF THE INVENTION

1. Field of the Invention

The present invention relates to the art of pizza making, and more particularly, to a support accessory for support of the peel and the crust while applying the sauce, cheese, and other toppings, prior to heating in the oven.

2. Description of the Prior Art

Most people are well versed in the making of pizza, even if they limit themselves to buying the preformed, frozen pizzas at the supermarket. In the pizza shop or parlor, the dough is typically preformed into a circular mound. This premeasured mound of dough is then worked by the pizza maker into a flat, circular disk of the appropriate size of pizza (small, medium, large). In a typical pizza shop or pizza parlor, this crust is then placed on the counter top, which in many instances is marble or stainless steel, in which it is further worked into a circular disk, having a slightly raised periphery. At this point in time the tomato sauce, cheese, and other toppings are applied to the crust, and the crust is then lifted via a peel, and slid into the pizza oven. The pizza maker would then brush off the counter top and repeat the process over and over again during the course of the stores operating hours.

In many instances, toppings sprinkled on the pizza crust are inadvertently sprinkled on the counter top, and in the haste and urgency of making pizzas, the counter top is not always as clean as one would desire. If these topping materials adhere to the underside of the peel when the pizza is transferred to the oven, both the oven floor and the peel become contaminated with burnt and melted cheeses, sauces, or toppings. This will cause subsequent pizza pies to stick in the oven and be difficult to remove from the peel and off of the oven floor resulting in down time while both the peel and the oven floor are cleaned. When the pies stick to the oven floor, the result is a portion of the pie being disfigured and non-consumable.

Applicant's invention is a pizza making accessory which cooperates with the counter top on which the pizzas are made, and allows for the pizza maker to place the crust directly on the peel before sprinkling the toppings. The accessory positions the peel and the pizza crust at a height above the counter top, such that any toppings which miss the upper surface of the pizza crust will fall to the counter top. The pizza maker then moves the peel and the pizza crust and toppings to the oven directly. The peel is returned to the accessory, and the process is repeated. The accessory allows for the crust to be formed into a circular disk directly on the peel and inserted directly into the oven, and the peel does not come in contact with the counter and thus the underside cannot become contaminated.

### OBJECTS OF THE INVENTION

An object of the present invention is to provide for a novel support accessory for making pizza.

A further object of the present invention is to provide for a novel support accessory which prevents contamination of the underside of the pizza crust.

A still further object of the present invention is to provide for a novel support accessory for making pizza which prevents hot spots on the underside of the pizza crust when baking.

A still further object of the present invention is to provide for a novel support accessory which prevents the underside of the peel from coming into contact with the countertop.

A still further object of the present invention is to provide for a novel support accessory which prevents the oven floor from becoming contaminated when making pizza.

### SUMMARY OF THE INVENTION

A support assembly for preventing contamination of a pizza peel or pizza oven, the support assembly cooperable with a counter top for support of a peel allowing for the pizza crust to be placed directly on the peel and the sauce, cheese and toppings sprinkled thereon, the support accessory comprising a support surface, the area of which is generally equal to or less than the area of the peel, the support surface elevated above the counter top by a plurality of support members, at least one support member depending a distance greater than the other support members so as to be juxtaposed the counter top edge so as to limit movement of the support accessory.

### BRIEF DESCRIPTION OF THE DRAWINGS

These and other objects of the present invention will become evident particularly when taken in light of the following illustrations wherein:

FIG. 1 is a perspective view of a first embodiment of the support accessory of the present invention;

FIG. 2 is a bottom view of the support accessory of FIG. 1;

FIG. 3 is a perspective view of the support accessory of FIG. 1 in cooperation with the counter top;

FIG. 4 is a perspective view of a second embodiment of the support accessory of the present invention;

FIG. 5 is a perspective view of a third embodiment of the support accessory of the present invention; and

FIG. 6 is a side view of the support accessory supporting a peel and pizza crust.

### DETAILED DESCRIPTION OF THE DRAWINGS

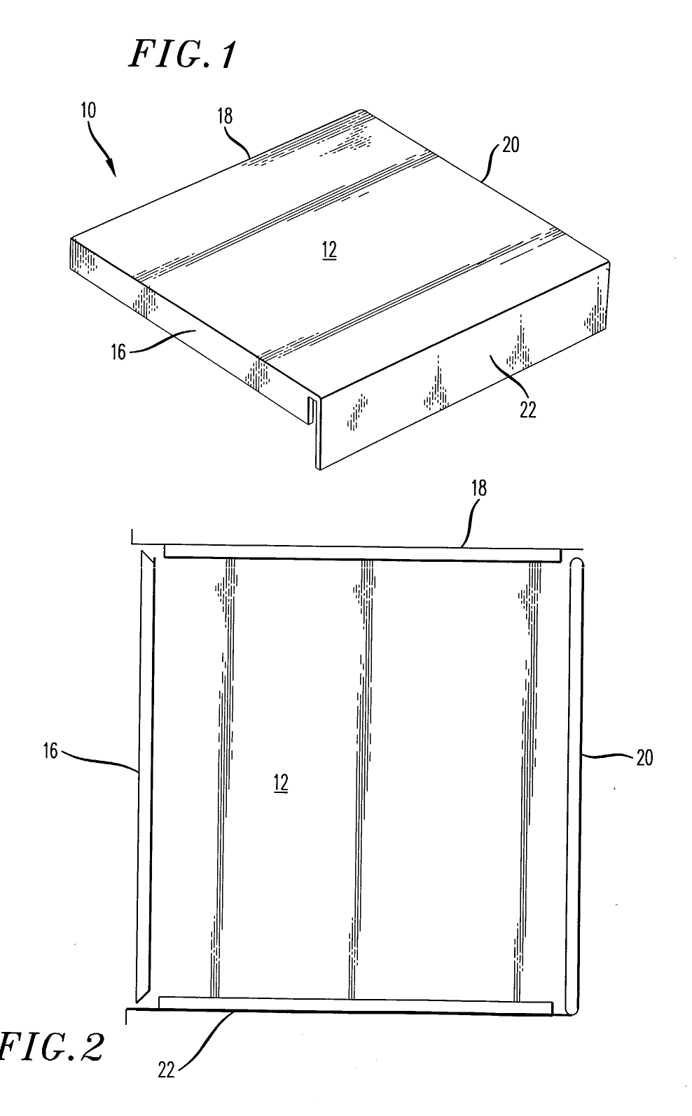

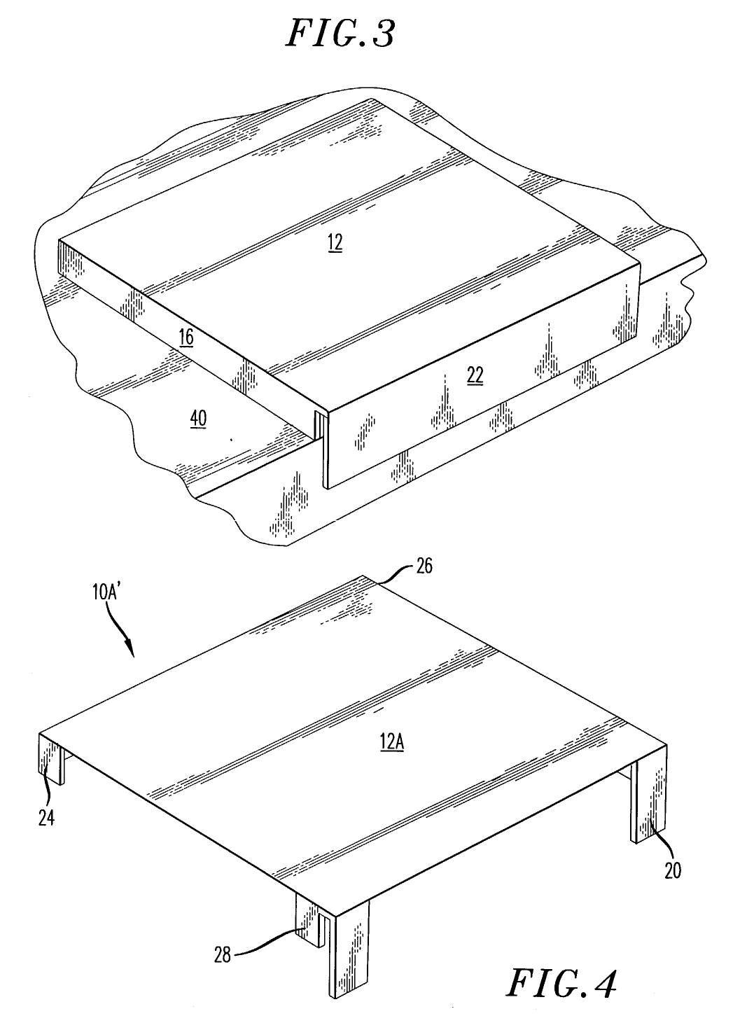

FIG. 1 is a perspective view of a first embodiment of the support accessory 10 of the present invention for facilitating the making of pizza. The support accessory 10 comprises a planar support surface 12 which is dimensioned to approximate the surface area of a standard peel used in making a pizza. Thus it would be in the range of approximately 17 inches by 17 inches, but may vary depending upon the size of the pizza. The planar support surface 12 in the embodiment illustrated in FIG. 1 is supported by a plurality of side panels or flanges 16, 18, 20 and 22, which extend from one side of the planar support surface 12 (see FIG. 2). Flanges 16, 18, 20 and 22 are substantially perpendicular to the planar surface and support the planar support surface 12 approximately in ¾ of an inch above the counter top. Side panel or flange 22 in a preferred embodiment would extend further than flanges 16, 18 and 20. This allows side panel or flange 22 to engage or abut the edge of the counter top so as to provide stability to the support accessory 10, as shown in FIG. 3.

The embodiment illustrated in FIG. 1 illustrates the side panels or flanges 16, 18, 20 and 22 to extend the length of each side of planar support surface 12. This represents one of the quickest and least expensive means of fabricating the support accessory 10 in that it can be fabricated from a single piece of metal with minimal cutting and with only four bending requirements. The support accessory 10 could also be fabricated out of any other suitable material, but for durability and long use, steel or other durable metal is preferred.

FIG. 4 represents a second embodiment of the present invention. In this configuration, support accessory 10A comprises a planar support surface 12A similar to the first embodiment, but rather than have depending side panels or flanges about the entire periphery of the planar support surface 12A, planar support surface 12A is supported by a plurality of legs, 24, 26, 28 and 30, which in this embodiment are positioned at the corners of the support accessory 10A. It will be noted that the stability of the support accessory 10A on the counter top is again achieved by having a portion of legs 28 and 30 extend a greater distance than legs 24 and 26, so that the extended portions 32 can engage the edge of the counter top 40 (not shown).

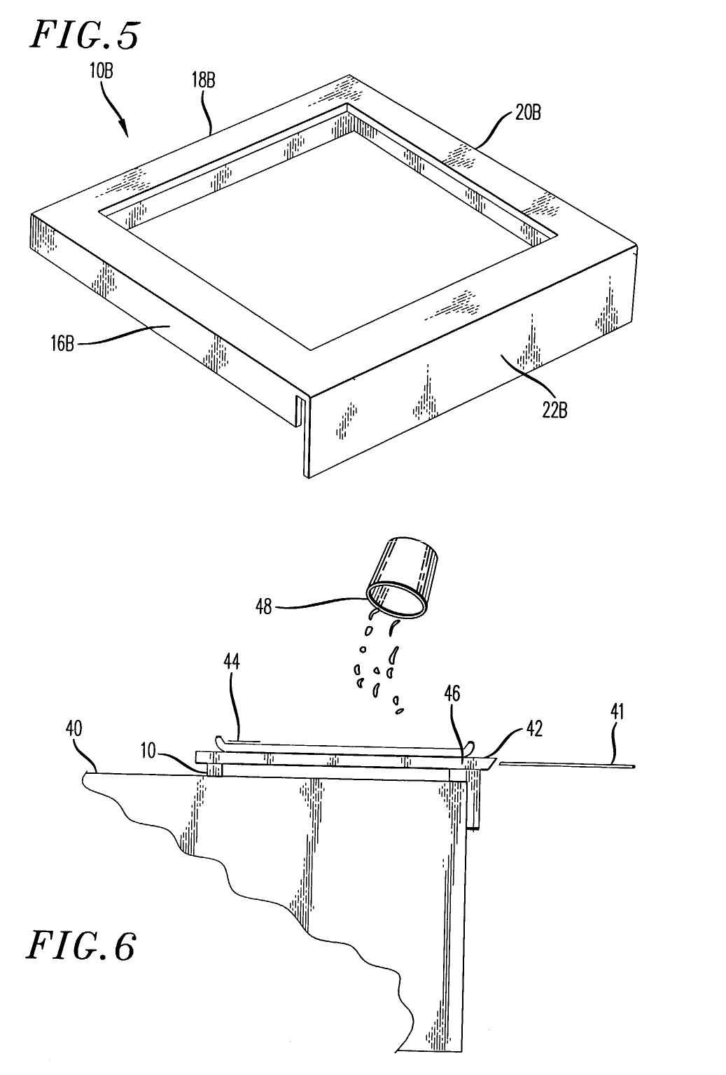

FIG. 5 is a perspective view of a third embodiment of the support accessory. The support accessory 10B illustrated in FIG. 5 is similar to the support accessory 10 of the first embodiment in that there are a plurality of side panels or flanges 16B, 18B, 20B, and 22B, designed to elevate a support surface above counter top 40. In this embodiment the support surface 12B is not a planar surface extending between all of the side panels and flanges, but rather is a peripheral surface running about the edges of the support accessory 10, each leg of the support surface 12B being of width sufficient such that support accessory 10B can support the weight of the peel and pizza. It will be recognized by those of ordinary skill in the art that the discontinuous nature of the support surface 12B could also be incorporated into second embodiment of Applicant's support accessory as illustrated in FIG. 4.

FIG. 6 is a side view of the counter top 40, support accessory 10, a typical pizza parlor peel 42 and handle 41 positioned on the support accessory 10, and a prepared pizza crust 44 positioned on the peel.

FIG. 6 illustrates that the underside 46 of pizza crust 44 does not contact the counter top 40, but rather is positioned on the peel 42 and that peel 42 does not contact counter top 40. The sauce, cheese and toppings 48 are applied to the crust and any excess or spilled toppings or cheese will fall to the counter top 40 such that the underside portion 46 of the pizza crust 44 and the underside of the peel 42 would not be contaminated by a stray piece of topping or cheese so as to create a hot spot when the pizza is inserted into the pizza oven. Operating in this fashion, the bottom of the peel 42 cannot become contaminated by spilled sauce, cheese or toppings on the counter top and thus could not transfer any of these items to the oven, such that the oven floor might become contaminated requiring down time to clean not only the oven floor, but also the peel.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A support accessory cooperable with a counter top for the prevention of the contamination of the oven floor or the pizza peel in the process of making a pizza, the support accessory comprising:
a plurality of vertically oriented support members each having an upper edge and a lower edge, said lower edge being in contact with a counter top surface, at least one of said plurality of support members having its said lower edge extending downwardly beyond the lower edge of the immediately adjacent support member and juxtaposed against a counter top edge;
a pizza peel support surface mounted on said plurality of support members, said peel support surface dimensioned to support a peel in a horizontal orientation.

2. The support accessory in accordance with claim 1 wherein said pizza peel support surface is planar and extends between said plurality of support members.

3. The support accessory in accordance with claim 1 wherein said plurality of support members comprises a plurality of side walls depending from said support surface about the periphery of said support surface.

4. The support accessory in accordance with claim 1 wherein said plurality of support members comprises distinct leg members depending from said support surface.

5. The support accessory in accordance with claim 3 wherein said support surface comprises an inwardly facing flange on each of said support members.

6. A method for preparing a pizza and insuring that the oven floor or pizza peel does not become contaminated, the process comprising:
positioning an elevated support surface on the counter top, said elevated support surface approximating the surface of a pizza peel, said elevated support surface having a depending member for engagement with the edge of the counter top;
positioning said pizza peel on said elevated support surface in a horizontal orientation;
positioning a pizza crust on said pizza peel;
applying desired pizza ingredients to said pizza crust;
transferring said pizza crust and said ingredients by means of said pizza peel to an oven.
